(19) United States
(12) Patent Application Publication
(10) Pub. No.: US 2007/0186877 A1
(43) Pub. Date: Aug. 16, 2007

(54) Fuel injection apparatus for an internal combustion engine

(76) Inventor: Udo Schulz, Vaihingen/Enz (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/591,809

(22) PCT Filed: Jan. 13, 2005
(86) PCT No.: PCT/EP05/50117

§ 371 Date: Sep. 6, 2006

(30) Foreign Application Priority Data
Mar. 9, 2004 (DE) 10 2004 011 282.7

(51) Int. Cl. F02B 47/02; B01D 29/00

(52) U.S. Cl. 123/25 A; 210/348

(57) ABSTRACT

The fuel injection apparatus has a high-pressure pump that supplies fuel at least indirectly to at least one injection point associated with at least one cylinder of the engine. The high-pressure pump is preceded by a fuel filter, which filters out impurities from the fuel and separates out free-floating water and/or emulsified water contained in the fuel. Free-floating and/or emulsified water separated out by the fuel filter is at least indirectly supplied to the combustion chamber of the at least one cylinder of the engine.

### PRIOR ART

The invention is based on a fuel injection apparatus for an internal combustion engine according to the preamble to claim 1.

A fuel injection apparatus of this kind is known from the literature, for example Dieselmotor-Management, Verlag Vieweg, 2^{nd} ed. 1998, pp. 280-284. This fuel injection apparatus has a high-pressure pump that supplies fuel into a reservoir. The reservoir is connected to injectors associated with the cylinders of the internal combustion engine. The high-pressure pump is preceded by a fuel filter that filters out impurities from the fuel to prevent them from damaging the high-pressure pump. The fuel filter also separates out free-floating water contained in the fuel and/or emulsified water, i.e. water that is mixed with fuel. The fuel filter has a collecting chamber for the separated water, which must be emptied from time to time. When there is a lot of water in the fuel, it may be necessary to empty the collected water after only a few hundred kilometers of driving. The separated water must also be disposed of in an environmentally responsible way because it is sometimes mixed with fuel.

### ADVANTAGES OF THE INVENTION

The fuel injection apparatus according to the present invention, with the defining characteristics of claim 1, has the advantage over the prior art that water separated out by the fuel filter does not require costly disposal, but is instead used in the combustion of the engine. Supplying water to the combustion process can also achieve advantages with regard to increased power, reduced emissions, and reduced thermal load on the engine.

The dependent claims disclose advantageous embodiments and modifications of the fuel injection apparatus according to the present invention. The embodiment according to claim 2 permits the supplied water to be dispersed in the aspirated combustion air. The embodiment according to claim 3 makes it possible for the supplied water to be delivered in the form of a fine spray. The embodiment according to claim 4 prevents the supplied water from settling in the intake region. In the embodiment according to claim 5, the water is subjected to the pressure generated by the fuel supply pump and can therefore be delivered without requiring an additional pump. The embodiment according to claim 9 prevents unwanted torque increase from occurring when the engine is in overrunning mode. The embodiment according to claim 10 prevents icing from occurring in the intake region. The embodiment according to claim 12 can prevent torque increase from occurring in the engine during water delivery.

### DRAWINGS

Several exemplary embodiments of the invention are shown in the drawings and explained in greater detail in the description below.

FIG. 1 schematically depicts a fuel injection apparatus for an internal combustion engine,

FIG. 2 is an enlarged depiction of a fuel filter of the fuel injection apparatus, and

FIG. 3 is an enlarged depiction of an intake region of a cylinder according to a modified embodiment.

### DESCRIPTION OF THE EXEMPLARY EMBODIMENTS

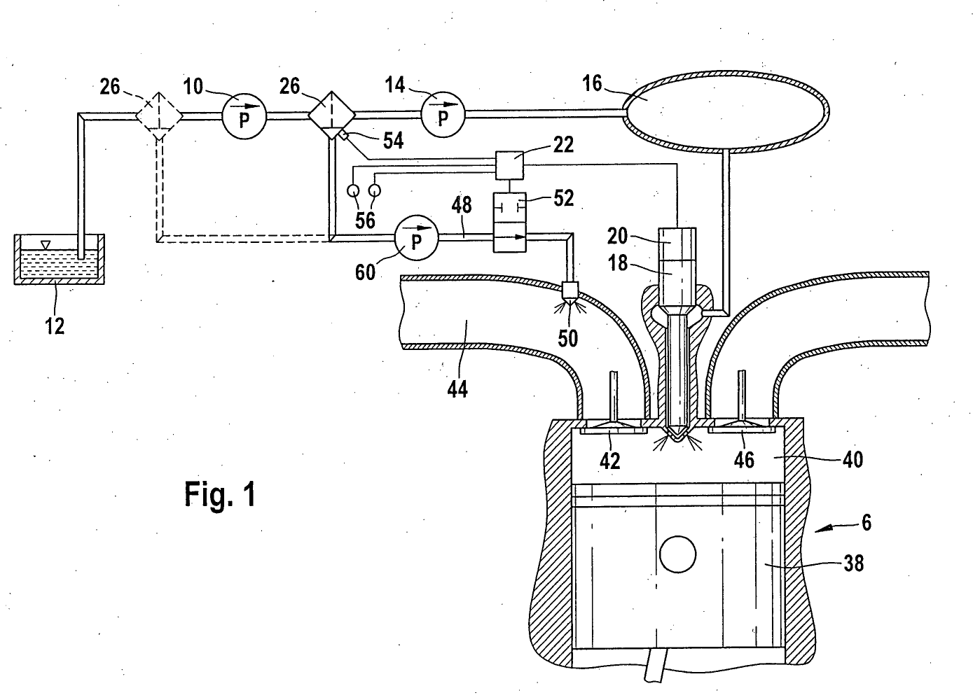

FIG. 1 shows a fuel injection apparatus for an internal combustion engine of a motor vehicle. The engine is preferably an autoignition engine and has one or more cylinders 6, only one of which is shown in FIG. 1. The fuel injection apparatus has a fuel supply pump 10 that supplies fuel from a tank 12 to a high-pressure pump 14. The high-pressure pump 14 supplies highly pressurized fuel to a reservoir 16. Hydraulic lines connect the reservoir to injectors 18 associated with the cylinders of the engine. Each injector 18 is provided with a control valve 20 that can open the injector 18 to initiate a fuel injection or close the injector to terminate a fuel injection. The control valves 20 of the injectors 18 are connected to an electronic control unit 22, which triggers them as a function of the operating parameters of the engine. The fuel injection device can alternatively also be provided with a high-pressure pump that is connected directly to the injectors 18; in this case, it is also possible to omit the control valves 20. As a further alternative, it is also possible to provide a separate high-pressure pump for each cylinder of the engine, which is connected only to the injector 18 of this cylinder and can form a structural unit with it.

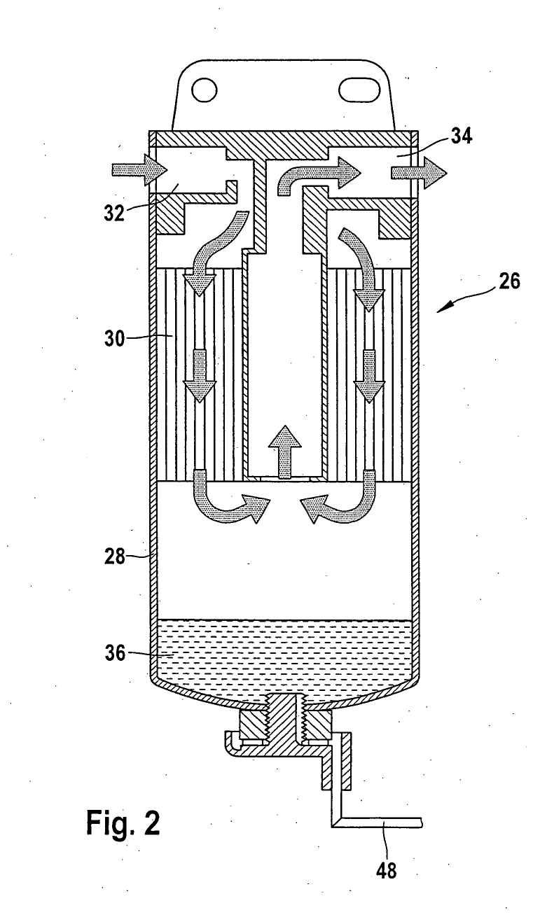

A fuel filter 26 is provided between the tank 12 and the high-pressure pump 14. The fuel filter 26 filters out impurities from the fuel so that they cannot get into the high-pressure pump 14 and damage it. The fuel filter 26 also separates out free-floating water contained in the fuel and/or emulsified water, i.e. water that is mixed with fuel. The water separation is executed through coalescence in the filter medium in which small water droplets settle on droplet bodies, for example of a metal grid structure. The small droplets join together to form larger droplets, growing, forming a film, and coalescing. The film can be removed or drawn from the fluid mixture, thus making it possible to separate a fuel/water mixture. The fuel filter 26 shown in an enlarged depiction in FIG. 2 has a housing 28 that contains a filter insert 30, for example made of paper. Fuel from the tank 12 enters the fuel filter 26 via an inlet 32, flows through the filter insert 30, and exits the fuel filter 26 via an outlet 34. In the region of the bottom of the filter housing 28, there is a collecting chamber 36 in which the separated water collects.

As shown in FIG. 1, the cylinder 6 of the internal combustion engine contains a piston 38 that executes a stroke motion inside the cylinder 6 and delimits a combustion chamber 40 therein. The combustion chamber 40 can be connected to an intake region 44 via at least one inlet valve 42 and can be connected to an exhaust region via at least one exhaust valve 46. During the intake stroke of the piston 38, the at least one inlet valve 42 is opened so that air, which is required to combust the fuel injected into the combustion chamber 40 by the injector 18, is sucked in from the intake region 44. The intake region 44 is embodied, for example, in the form of an intake tube.

According to the present invention, free-floating and/or emulsified water separated out by the fuel filter 26 is supplied to the combustion chamber 40 of the cylinder 6. To this end, the collecting chamber 36 of the fuel filter 26 is connected to the intake region 44 of the cylinder 6, for example, via a line 48 so that water is supplied to the combustion air that is then sucked in by the cylinder 6. Preferably, a nozzle 50 or an injection valve delivers the water into the intake region 44 in spray form in order to achieve a uniform mixture with the combustion air. Preferably, the water is delivered into the intake region 44 directly at the injection valve 42 or only a slight distance upstream of it. The line 48 contains an on-off valve 52 triggered by the control unit 22. Preferably, the on-off valve 52 is controlled as a function of operating parameters of the engine and/or as a function of the quantity of water present in the collecting chamber 36 of the fuel filter 26. In a multicylinder internal combustion engine, it is alternatively possible for the water to be supplied to the intake region 44 of only one cylinder or to the intake regions of all of the cylinders. A shared on-off valve 52 can be provided for a shared line 48 to all of the cylinders of the engine, which line branches to the separate intake regions of the cylinders only after the on-off valve 52, or a separate on-off valve 52 can be provided for the intake region 44 of each cylinder. It is also possible for the water separated in the fuel filter 26 to be supplied to the intake region of only one cylinder of the engine.

The quantity of water present in the collecting chamber 36 can be detected, for example, by a conductivity sensor 54 that is connected to the control unit 22. The control unit 22 opens the on-off valve 52 only if it has determined from the signal of the sensor 54 that water is present in the collecting chamber 36. Additional sensors 56 are provided to detect operating parameters of the engine, for example to detect the load state, the crank angle, the temperature, and possibly other parameters. For example, the control unit 22 opens the on-off valve 52, thus supplying water into the intake region 44, only when the engine is not in overrunning mode, i.e. at zero load, and when the inlet valve 42 is open. This assures that no injection of fuel mixed with water occurs in overrunning mode, which would lead to an unwanted increase in the torque of the engine and assures that the supplied water is sucked directly into the combustion chamber 40 and is not deposited in the intake region 44.

The free-floating and/or emulsified water supplied to the combustion chamber 40 can cause an increase in the torque of the engine. Such a torque increase, particularly when the engine is in idling mode, would lead to an increase in the engine speed, which can be compensated for by an idle control, in that the control unit 22 reduces the quantity of fuel injected by the injector 18 in order to keep the torque and therefore the speed at least approximately constant. When the engine is operated in the partial or full load range, the increase in engine torque caused by the supply of the water is most often so insignificant that it does not need to be compensated for. If necessary, however, it is also possible for the control unit 22 to compensate for the increase in the torque caused by the water supply by reducing the quantity of fuel injected by the injectors 18 in the partial and/or full load range of the engine as well. The required reduction in the fuel injection quantity in order to compensate for the increase in the torque due to the supply of water can be approximated by modeling and stored in a characteristic field in the control unit 22. If the quantity of water, in particular emulsified water, supplied per combustion cycle of the engine can be kept very low, then it is not necessary to reduce the fuel quantity injected by the injectors 18. In addition, the control unit 22 triggers a supply of water into the intake region 44 only at temperatures above the freezing point in order to prevent the occurrence of icing in the intake region 44.

The control unit 22 must close the on-off valve 52 when there is no more water in the collecting chamber 36 of the fuel filter 26 to prevent fuel from being drawn from the fuel filter 26 and supplied to the intake region 44. An additional conductivity sensor can be provided here, which detects when the collecting chamber 36 is nearly empty, at which point the control unit 22 closes the on-off valve 52. Alternatively, it is also possible for the control unit 22 to detect an increase in engine torque, which makes it possible to detect the supply of fuel into the intake region 44 in addition to the fuel quantity injected by the injector 18. If the torque increase exceeds a predetermined value, then the control unit 22 closes the on-off valve 52. Toward the end of the supply of water into the intake region 44, it is possible for the line 48 to be filled with fuel from the fuel filter 26. With further operation of the engine, the fuel filter 26 separates out additional free-floating and/or emulsified water, which, due to the different densities of water and fuel, at least partially displaces the fuel present in the line 48 back into the fuel filter 26 so that in the next cycle of water delivery into the intake region 44, only a small quantity of fuel travels into the intake region 44 from the line 48. A displacement of the fuel present in the line 48 back into the fuel filter 26 can be assisted through a suitable routing of the line 48 that encourages the fuel to rise up out of the line 48 and into the fuel filter 26.

In addition to a torque increase, the supply of water to the combustion chamber 40 of the cylinder 6 also reduces pollutant emissions from the internal combustion engine since the water reduces the combustion temperature, which reduces the formation of nitrogen oxides. In particular, the reduction of the combustion temperature can also reduce the thermal load on components of the engine.

The fuel filter 26 can be situated between the fuel supply pump 10 and the high-pressure pump 14, as depicted with solid lines in FIG. 1. The fuel supply pump 10 here can be an electrically driven pump and can be contained in the tank 12. Fuel flows through the fuel filter 26 at the delivery pressure generated by the fuel supply pump 10, which lies between 2 and 10 bar, for example. The water collected in the collecting chamber 36 is likewise at the delivery pressure generated by the fuel supply pump 10 and is propelled by this pressure to the intake region 44 and then atomized in the nozzle 50 or in the injection valve.

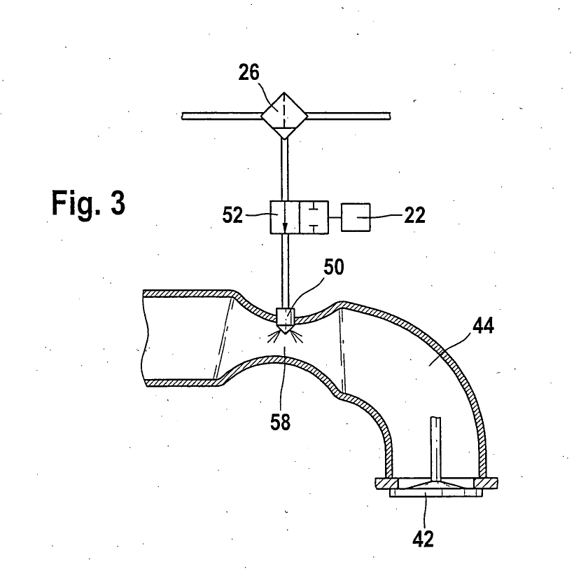

Alternatively, the fuel filter 26 can also be situated between the fuel supply pump 10 and the fuel tank 12, as depicted with dashed lines in FIG. 1. In this case, fuel drawn in by the fuel supply pump 10 flows through the fuel filter 26 so that a pressure lower than atmospheric pressure prevails in the filter. The intake region 44, as depicted in FIG. 3, can contain a cross-sectional constriction, for example in the form of a venturi nozzle 58 fed by the line 48 leading from the fuel filter 26. The aspirated combustion air flows through in the cross-sectional constriction 58 at a high speed and therefore at a low static pressure, which causes the airflow to draw water from the fuel filter 26. It is possible for the cross-sectional constriction 58 to only be present when water is being supplied to the intake region 44. As a result, the cross section of the intake region 44 would not always be constricted, thus avoiding negatively influencing the operation of the engine. The intake region 44 could be provided with an annular volume that can be elastically expanded, for example by being inflated with air or gas, in order to produce the cross-sectional constriction 58. Alternatively, it is also possible for a diaphragm to be slid into and out of the intake region 44 in order to produce or eliminate the cross-sectional constriction 58. For example, an electrical actuator can slide the diaphragm in and out. Alternatively, it is also possible to provide a pump 60 in the line 48 in order to deliver the water from the fuel filter 26 to the intake region 44. The pump 60 is preferably equipped with an electrical drive unit and is controlled by the control unit 22 so that the pump 60 is only operated when it is necessary to drain water from the fuel filter 26.

1-12. (canceled)

13. A fuel injection apparatus for an internal combustion engine, the apparatus comprising
a high-pressure pump that supplies fuel at least indirectly to at least one injection point associated with at least one cylinder of the engine,
a fuel filter preceding the high-pressure pump, which filters out impurities from the fuel and separates out free-floating water contained in the fuel and/or emulsified water, and
means for at least indirectly supplying free-floating and/or emulsified water separated out by the fuel filter to the combustion chamber of the at least one cylinder of the engine.

14. The fuel injection apparatus according to claim 13, wherein the free-floating and/or emulsified water is supplied to an intake region of the at least one cylinder from which intake region combustion air is sucked into the combustion chamber of the cylinder.

15. The fuel injection apparatus according to claim 14, wherein the free-floating and/or emulsified water is sprayed into the intake region by means of a nozzle or an injection valve.

16. The fuel injection apparatus according to claim 14, wherein the free-floating and/or emulsified water is supplied to the intake region at least essentially only during the intake phase of the at least one cylinder.

17. The fuel injection apparatus according to claim 15, wherein the free-floating and/or emulsified water is supplied to the intake region at least essentially only during the intake phase of the at least one cylinder.

18. The fuel injection apparatus according to claim 13, wherein the fuel filter is situated downstream of a fuel supply pump that supplies fuel to the high-pressure pump, and wherein the free-floating and/or emulsified water is conveyed out of the fuel filter by the delivery pressure generated by the fuel supply pump.

19. The fuel injection apparatus according to claim 14, wherein the means for at least indirectly supplying free floating and/or emulsified water comprises a conduit connected between the fuel filter and the intake region and an-off valve in the conduit.

20. The fuel injection apparatus according to claim 16, wherein the means for at least indirectly supplying free floating and/or emulsified water comprises a conduit connected between the fuel filter and the intake region and an-off valve in the conduit.

21. The fuel injection apparatus according to claim 17, wherein the means for at least indirectly supplying free floating and/or emulsified water comprises a conduit connected between the fuel filter and the intake region and an-off valve in the conduit.

22. The fuel injection apparatus according to claim 14, wherein the intake region has a cross-sectional constriction, and wherein the free-floating and/or emulsified water is supplied to the intake region in its cross-sectional constriction.

23. The fuel injection apparatus according to claim 16, wherein the intake region has a cross-sectional constriction, and wherein the free-floating and/or emulsified water is supplied to the intake region in its cross-sectional constriction.

24. The fuel injection apparatus according to claim 17, wherein the intake region has a cross-sectional constriction, and wherein the free-floating and/or emulsified water is supplied to the intake region in its cross-sectional constriction.

25. The fuel injection apparatus according to claim 18, wherein the intake region has a cross-sectional constriction, and wherein the free-floating and/or emulsified water is supplied to the intake region in its cross-sectional constriction.

26. The fuel injection apparatus according to claim 14, further comprising an electronic control unit operable to control the supply of the free-floating and/or emulsified water to the intake region as a function of operating parameters of the engine.

27. The fuel injection apparatus according to claim 16, further comprising an electronic control unit operable to control the supply of the free-floating and/or emulsified water to the intake region as a function of operating parameters of the engine.

28. The fuel injection apparatus according to claim 26, wherein the control unit is operable to prevent free-floating and/or emulsified water from being supplied when the engine is in overrunning mode.

29. The fuel injection apparatus according to claim 26, wherein the control unit is operable to supply free-floating and/or emulsified water at temperatures above the freezing point.

30. The fuel injection apparatus according to claim 27, wherein the control unit is operable to supply free-floating and/or emulsified water at temperatures above the freezing point.

31. The fuel injection apparatus according to claim 14, wherein the control unit is operable to supply free-floating and/or emulsified water at least essentially only during a respective intake phase of the at least one cylinder when the combustion air is being sucked from the intake region into the combustion chamber of the cylinder.

32. The fuel injection apparatus according to claim 14, wherein the electronic control unit is operable to reduce the quantity of fuel injected at the at least one injection point as a function of the quantity of free-floating and/or emulsified water supplied to the intake region.
